(19) United States
(12) Patent Application Publication
(10) Pub. No.: US 2024/0129952 A1
(43) Pub. Date: Apr. 18, 2024

(54) Transmission Preemption for Wi-Fi

(71) Applicant: Apple Inc., Cupertino, CA (US)

(72) Inventors: Ahmad Reza Hedayat, Carlsbad, CA (US); Lochan Verma, Danville, CA (US); Tianyu Wu, Fremont, CA (US); Jarkko L. Kneckt, Los Gatos, CA (US); Yong Liu, Campbell, CA (US); Jinjing Jiang, San Jose, CA (US); Su Khiong Yong, Palo Alto, CA (US)

(21) Appl. No.: 18/465,448

(22) Filed: Sep. 12, 2023

Related U.S. Application Data
(60) Provisional application No. 63/416,336, filed on Oct. 14, 2022.

(51) Int. Cl. H04W 74/08

(52) U.S. Cl. CPC H04W 74/0816; H04W 74/0866

(57) ABSTRACT

This disclosure relates to methods for transmission preemption in a wireless local area network. An access point wireless device may establish a wireless association with another wireless device. A first data transmission may be initiated. The transmitting wireless device may determine to preempt the first data transmission prior to its completion. The transmitting wireless device may transmit signaling indicating that the first data transmission is preempted.

### PRIORITY INFORMATION

This application claims priority to U.S. provisional patent application Ser. No. 63/416,336, entitled “Transmission Preemption for Wi-Fi,” filed Oct. 14, 2022, which is hereby incorporated by reference in its entirety as though fully and completely set forth herein.

### TECHNICAL FIELD

The present application relates to wireless communication, including techniques and devices for transmission preemption in a wireless local area network architecture.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices, or user equipment devices (UEs) may take the form of smart phones or tablets that a user typically carries. One aspect of wireless communication that may commonly be performed by UEs may include wireless networking, for example over a wireless local area network (WLAN), which may include devices that operate according to one or more communication standards in the IEEE 802.11 family of standards. In a wireless local area network in which multiple wireless devices are active, it may be possible that traffic between certain devices can be delayed while communications between other devices in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for devices to perform transmission preemption in a wireless local area network architecture.

A wireless device may include one or more antennas, one or more radios operably coupled to the one or more antennas, and a processor operably coupled to the one or more radios. The wireless device may be configured to establish a connection with an access point through a wireless local area network (WLAN) over one or multiple wireless links, or may be an access point configured to establish a connection with one or more other wireless devices through a WLAN over one or multiple wireless links. The wireless device may operate in each of the multiple wireless links using a respective radio of the one or more radios.

According to the techniques described herein, it may be possible to preempt an ongoing transmission in a Wi-Fi based wireless communication setting. At least in some embodiments, it may be possible to provide an indication of whether preemption of a given communication frame is supported, for example at the beginning of each communication frame, e.g., in physical layer signaling information for the communication frame.

For a communication frame for which preemption is supported, the wireless device that is transmitting the frame may, for example, provide signaling during the data frame that is configured to indicate that the remainder of the transmission is preempted. The signaling can be based on a physical layer waveform and/or media access control layer signaling, according to various embodiments. The signaling may be received by the recipient wireless device of the ongoing data frame, which may facilitate handling by this wireless device without causing errors. The signaling may also be received by one or more potential beneficiary wireless devices of the transmission preemption, which may facilitate detection of a follow up transmission to one of those potential beneficiaries that may have been the trigger for the transmission preemption. For example, the transmission preemption may be triggered based at least in part on arrival of traffic that is considered low-latency or delay-intolerant traffic for a wireless device in the Wi-Fi based network, and the follow up transmission may include a transmission of the low-latency or delay-intolerant traffic to the corresponding wireless device.

The transmission preemption techniques described herein include techniques that may be used in conjunction with either or both of single-user or multi-user communication frames, according to various embodiments. Additionally, the techniques described herein include techniques that can be used in conjunction with either or both of uplink or downlink communication frames, according to various embodiments.

The techniques described herein may be implemented in and/or used with a number of different types of devices, including but not limited to cellular phones, tablet computers, accessory and/or wearable computing devices, portable media players, cellular base stations and other cellular network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a user equipment device (UE), according to some embodiments;

FIG. 2 is a block diagram illustrating an example UE, according to some embodiments;

FIG. 3 is a block diagram illustrating an example network element or access point, according to some embodiments;

FIG. 4 is a flowchart diagram illustrating an example method for performing transmission preemption in a wireless local area network, according to some embodiments;

FIGS. 5-10 illustrate various possible example transmission timelines with and without transmission preemption in a wireless local area network setting, according to some embodiments;

FIG. 11 illustrates example aspects of a possible media access control based signaling mechanism for transmission preemption in a wireless local area network setting, according to some embodiments;

FIGS. 12-13 illustrate example aspects of possible transmission preemption techniques in a wireless local area network setting with multi-user transmission, according to some embodiments;

FIGS. 14-15 illustrate various possible example transmission timelines with and without transmission preemption in a wireless local area network setting with multi-user transmission, according to some embodiments;

FIG. 16 is a flowchart diagram illustrating an example method for a wireless device that is a beneficiary of transmission preemption in a wireless local area network setting, according to some embodiments;

FIGS. 17-19 illustrate further possible example transmission timelines with transmission preemption in a wireless local area network setting with multi-user transmission, according to some embodiments; and

FIG. 20 illustrates an example transmission timeline with uplink transmission preemption in a wireless local area network setting with multi-user transmission, according to some embodiments;

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPGAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)— any of various types of computer systems or devices that are mobile or portable and that perform wireless communications. Examples of UE devices include mobile telephones or smart phones (e.g., iPhone™, Android™-based phones), portable gaming devices (e.g., Nintendo DS™ PlayStation Portable™, Gameboy Advance™, iPhone™), laptops, wearable devices (e.g. smart watch, smart glasses), PDAs, portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)— any of various types of computer systems or devices that perform wireless communications. A wireless device can be portable (or mobile) or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)— The term “Base Station” (also called “eNB”) has the full breadth of its ordinary meaning, and at least includes a wireless communication station installed at a fixed location and used to communicate as part of a wireless communication system. The term “access point” (or “AP”) is used similarly.

Processing Element (or Processor)—refers to various elements or combinations of elements that are capable of performing a function in a device, e.g., in a user equipment device or in a network infrastructure device. Processors may include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

IEEE 802.11— refers to technology based on IEEE 802.11 wireless standards such as 802.11a, 802.11.b, 802.11g, 802.11n, 802.11-2012, 802.11ac, 802.11ad, 802.11ax, 802.1 lay, 802.11be, and/or other IEEE 802.11 standards. IEEE 802.11 technology may also be referred to as “Wi-Fi” or “wireless local area network (WLAN)” technology.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

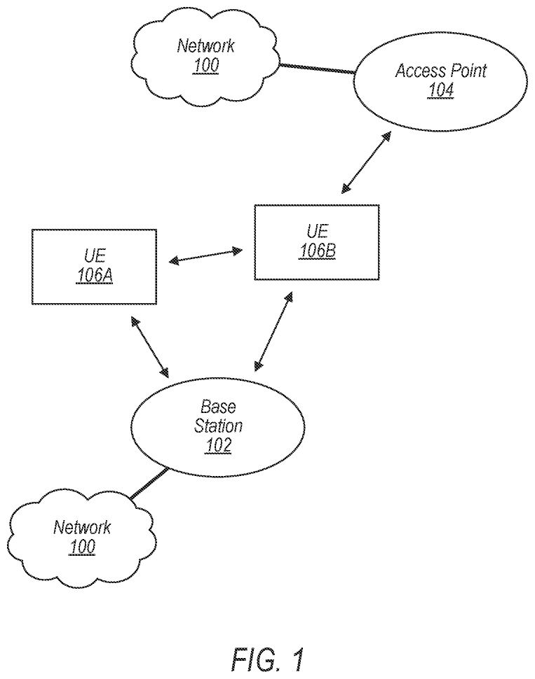

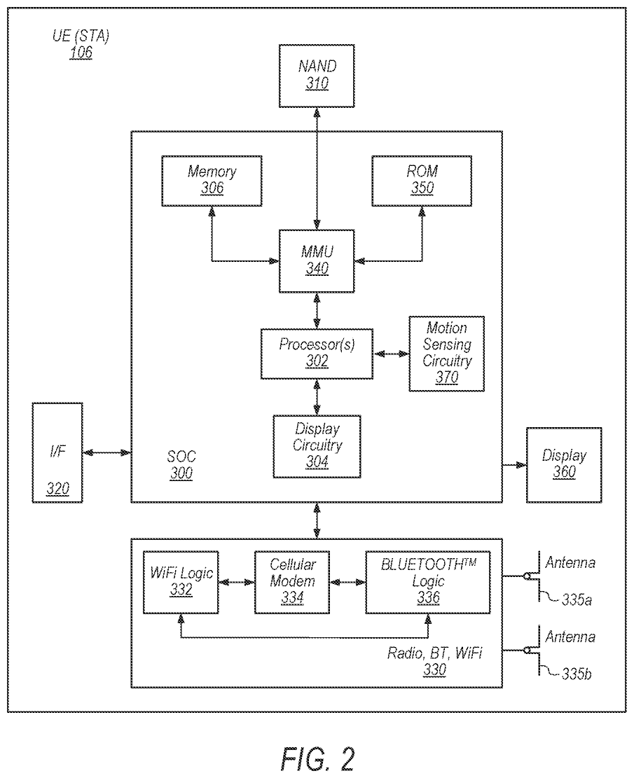

### FIGS. 1-2— Wireless Communication System

FIG. 1 illustrates an example of a wireless communication system. It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown, the exemplary wireless communication system includes a cellular base station 102, which communicates over a transmission medium with one or more wireless devices 106A, 106B, etc. Wireless devices 106A and 106B may be user devices, which may be referred to herein as “user equipment” (UE), UEs, or UE devices.

The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The base station 102 may be a base transceiver station (BTS) or cell site, and may include hardware that enables wireless communication with the UE devices 106A and 106B. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the UE devices 106 and/or between the UE devices 106 and the network 100. In other implementations, base station 102 can be configured to provide communications over one or more other wireless technologies, such as an access point supporting one or more WLAN protocols, such as 802.11 a, b, g, n, ac, ad, ax, ay, be and/or other 802.11 versions, or LTE in an unlicensed band (LAA).

The communication area (or coverage area) of the base station 102 may be referred to as a “cell.” The base station 102 and the UEs 106 may be configured to communicate over the transmission medium using any of various radio access technologies (RATs) or wireless communication technologies, such as LTE, LTE-Advanced (LTE-A), 5G NR, Wi-Fi, ultra-wideband (UWB), etc.

Base station 102 and other similar base stations (not shown) operating according to one or more cellular communication technologies may thus be provided as a network of cells, which may provide continuous or nearly continuous overlapping service to UE devices 106A-B and similar devices over a geographic area via one or more cellular communication technologies.

Note that at least in some instances a UE device 106 may be capable of communicating using any of multiple wireless communication technologies. For example, a UE device 106 might be configured to communicate using one or more of LTE, LTE-A, 5G NR, WLAN, Bluetooth, UWB, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances a UE device 106 may be configured to communicate using only a single wireless communication technology.

As shown, the exemplary wireless communication system also includes a WLAN access point (AP) 104, which communicates over a transmission medium with the wireless device 106B. The WLAN access point, which may be a Wi-Fi AP, also provides communicative connectivity to the network 100. Thus, according to some embodiments, wireless devices may be able to connect to either or both of the base station 102 (or another cellular base station) and the access point 104 (or another access point) to access the network 100 at a given time.

The UEs 106A and 106B may include handheld devices such as smart phones or tablets, wearable devices such as smart watches or smart glasses, and/or may include any of various types of devices with cellular communications capability. For example, one or more of the UEs 106A and 106B may be a wireless device intended for stationary or nomadic deployment such as an appliance, measurement device, control device, etc.

The UE 106B may also be configured to communicate with the UE 106A. For example, the UE 106A and UE 106B may be capable of performing direct device-to-device (D2D) communication. The D2D communication may be supported by the cellular base station 102 (e.g., the BS 102 may facilitate discovery, among various possible forms of assistance), or may be performed in a manner unsupported by the BS 102.

The UE 106 may include one or more devices or integrated circuits for facilitating wireless communication, potentially including a cellular modem and/or one or more other wireless modems. The wireless modem(s) may include one or more processors (processor elements) and various hardware components as described herein. The UE 106 may perform any of the method embodiments described herein by executing instructions on one or more programmable processors. Alternatively, or in addition, the one or more processors may be one or more programmable hardware elements such as an FPGA (field-programmable gate array), application-specific integrated circuit (ASIC), or other circuitry, that is configured to perform any of the method embodiments described herein, or any portion of any of the method embodiments described herein. The wireless modem(s) described herein may be used in a UE device as defined herein, a wireless device as defined herein, or a communication device as defined herein. The wireless modem described herein may also be used in a base station or other similar network side device.

The UE 106 may include one or more antennas for communicating using two or more wireless communication protocols or radio access technologies. In some embodiments, the UE device 106 might be configured to communicate using a single shared radio. The shared radio may couple to a single antenna, or may couple to multiple antennas (e.g., for MIMO) for performing wireless communications. Alternatively, the UE device 106 may include two or more radios, each of which may be configured to communicate via a respective wireless link. Other configurations are also possible.

### FIG. 2— Example Block Diagram of a UE Device

FIG. 2 illustrates one possible block diagram of a UE device, such as UE device 106. In some instances (e.g., in an 802.11 communication context), the UE 106 may alternatively be referred to as a station (STA) 106, and possibly more particularly as a non-AP STA 106. As shown, the UE device 106 may include a system on chip (SOC) 300, which may include portions for various purposes. For example, as shown, the SOC 300 may include processor(s) 302 which may execute program instructions for the UE device 106, and display circuitry 304 which may perform graphics processing and provide display signals to the display 360. The SOC 300 may also include motion sensing circuitry 370 which may detect motion of the UE 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, 5G NR, Bluetooth, Wi-Fi, NFC, GPS, UWB, etc.).

The UE device 106 may include at least one antenna, and in some embodiments multiple antennas 335a and 335b, for performing wireless communication with base stations and/or other devices. For example, the UE device 106 may use antennas 335a and 335b to perform the wireless communication. As noted above, the UE device 106 may in some embodiments be configured to communicate wirelessly using a plurality of wireless communication standards or radio access technologies (RATs).

The wireless communication circuitry 330 may include Wi-Fi Logic 332, a Cellular Modem 334, and Bluetooth Logic 336. The Wi-Fi Logic 332 is for enabling the UE device 106 to perform Wi-Fi or other WLAN communications on an 802.11 network. The Bluetooth Logic 336 is for enabling the UE device 106 to perform Bluetooth communications. The cellular modem 334 may be a cellular modem capable of performing cellular communication according to one or more cellular communication technologies.

As described herein, UE 106 may include hardware and software components for implementing embodiments of this disclosure. For example, one or more components of the wireless communication circuitry 330 (e.g., Wi-Fi logic 332, cellular modem 334, BT logic 336) of the UE device 106 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

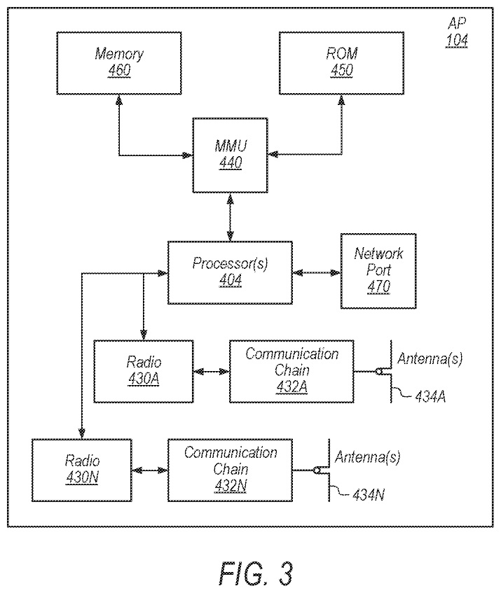

### FIG. 3— Block Diagram of an Access Point

FIG. 3 illustrates an example block diagram of an access point (AP) 104, according to some embodiments. In some instances (e.g., in an 802.11 communication context), the AP 104 may also be referred to as a station (STA), and possibly more particularly as an AP STA. It is noted that the AP of FIG. 3 is merely one example of a possible access point. As shown, AP 104 may include processor(s) 404 which may execute program instructions for the AP 104. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The AP 104 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The AP 104 may include one or more radios 430A-430N, each of which may be coupled to a respective communication chain and at least one antenna 434, and possibly multiple antennas. The antenna(s) 434 may be configured to operate as a wireless transceiver and may be further configured to communicate with UE devices 106/107 via radio 430. The antenna(s) 434A-N communicate with their respective radios 430A-N via communication chains 432A-N. Communication chains 432 may be receive chains, transmit chains, or both. The radios 430A-N may be configured to communicate via various wireless communication standards, including, but not limited to, LTE, LTE-A, 5G NR, UWB, Wi-Fi, etc. The UE 104 may be configured to operate in multiple wireless links using the one or more radios 430A-N, wherein each radio is used to operate in a respective wireless link.

The AP 104 may be configured to communicate wirelessly using multiple wireless communication standards. In some instances, the AP 104 may include multiple radios, which may enable the network entity to communicate according to multiple wireless communication technologies. For example, as one possibility, the AP 104 may include an LTE or 5G NR radio for performing communication according to LTE as well as a Wi-Fi radio for performing communication according to Wi-Fi. In such a case, the AP 104 may be capable of operating as both an LTE base station and a Wi-Fi access point. As another possibility, the AP 104 may include a multi-mode radio which is capable of performing communications according to any of multiple wireless communication technologies (e.g., 5G NR and Wi-Fi, 5G NR and LTE, etc.). As still another possibility, the AP 104 may be configured to act exclusively as a Wi-Fi access point, e.g., without cellular communication capability.

As described further subsequently herein, the AP 104 may include hardware and software components for implementing or supporting implementation of features described herein. The processor 404 of the access point 104 may be configured to implement or support implementation of part or all of the methods described herein, e.g., by executing program instructions stored on a memory medium (e.g., a non-transitory computer-readable memory medium) to operate multiple wireless links using multiple respective radios. Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the AP 104, in conjunction with one or more of the other components 430, 432, 434, 440, 450, 460, 470 may be configured to implement or support implementation of part or all of the features described herein.

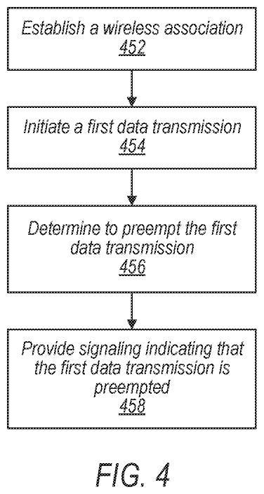

### FIG. 4— Flowchart

FIG. 4 is a flowchart diagram illustrating a method for supporting transmission preemption in a WLAN, according to some embodiments. In various embodiments, some of the elements of the methods shown may be performed concurrently, in a different order than shown, may be substituted for by other method elements, or may be omitted. Additional method elements may also be performed as desired.

Aspects of the method of FIG. 4 may be implemented by a wireless device, such as the AP 104 or UE 106 illustrated in and described with respect to FIGS. 1-3, or more generally in conjunction with any of the computer circuitry, systems, devices, elements, or components shown in the Figures, among others, as desired. For example, a processor (and/or other hardware) of such a device may be configured to cause the device to perform any combination of the illustrated method elements and/or other method elements.

Note that while at least some elements of the method of FIG. 4 are described in a manner relating to the use of communication techniques and/or features associated with IEEE 802.11 specification documents, such description is not intended to be limiting to the disclosure, and aspects of the method of FIG. 4 may be used in any suitable wireless communication system, as desired. As shown, the methods may operate as follows.

At least two wireless devices may establish a wireless association (452). The wireless association may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

The AP wireless device may initiate a first data transmission to another wireless device with which it has formed an association (454). At least according to some embodiments, initiating the first data transmission may include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs).

In some embodiments, it may be possible to include control information for the first data transmission (e.g., in the PHY header information) indicating whether preemption of the first data transmission is possible. For example, the AP wireless device may determine whether there may be cause to preempt the first data transmission, and if there may potentially be cause to preempt the first data transmission, the AP wireless device may include signaling to indicate that preemption of the first data transmission is possible. There may be a variety of potential causes for determining to support the possibility of preempting the first data transmission. As one such possibility, in some instances, the AP wireless device may determine that there may be cause to preempt the first data transmission if the first data transmission is for relatively delay tolerant traffic (e.g., where delay tolerance can be determined based on a traffic identifier (TID) and/or other data type information associated with the first data transmission) and one or more wireless devices in the network provided by the AP wireless device have active low-latency traffic streams (e.g., where low-latency preferences or requirements can be determined based on a traffic identifier (TID) and/or other data type information associated with a traffic stream). For example, in such a scenario, it may be determined to be worthwhile to preempt the first data transmission in order to be able to more quickly transmit delay intolerant traffic that arrives at the AP wireless device (e.g., from a wide area network, such as the Internet, or another source) prior to the scheduled end of the first data transmission.

If the AP wireless device determines that there may not be any cause to preempt the first data transmission, it may be possible that the AP wireless device includes signaling to indicate that preemption of the first data transmission is not possible. Alternatively, it may be the case that if no explicit signaling is included to indicate that preemption of the first data transmission is possible, it may be implicitly be assumed that preemption of the first data transmission is not possible. As one example of a scenario in which the AP wireless device could potentially determine that there may not be any cause to preempt the first data transmission, in some instances, the AP wireless device could be configured to determine that there is no cause to preempt the first data transmission if no wireless devices in the network provided by the AP wireless device have active low-latency traffic streams. As another (additional or alternative) possibility, the AP wireless device could be configured to determine that there is no cause to preempt the first data transmission if the first data transmission itself is associated with a low-latency (or otherwise high priority) traffic stream.

The AP wireless device may determine to preempt the first data transmission (456). The determination to preempt the first data transmission may be for any of a variety of possible reasons. As previously noted, in some instances, the determination could be based at least in part on arrival of low latency traffic at the AP wireless device during the first data transmission.

A further possible consideration (e.g., in conjunction with arrival of low latency traffic) could include the scheduled duration of the first data transmission. For example, determination of whether to preempt the first data transmission could depend at least in part on whether the remaining time needed to complete the first data transmission when the low latency traffic arrives is less than or greater than a certain threshold; as one such possibility, if the remaining duration of the first data transmission is less than the threshold, the AP wireless device may determine to not preempt the first data transmission, while if the remaining duration of the first data transmission is greater than the threshold, the AP wireless device may determine to preempt the first data transmission.

Yet another possible consideration could include a traffic type or priority associated with the first data transmission. For example, determination of whether to preempt the first data transmission could depend at least in part on whether the first data transmission is itself associated with low latency or otherwise high priority traffic; as one such possibility, if the first data transmission is associated with low latency or otherwise high priority traffic, the AP wireless device may determine to not preempt the first data transmission when low latency traffic arrives, while if first data transmission is not associated with low latency or otherwise high priority traffic, the AP wireless device may determine to preempt the first data transmission when low latency traffic arrives.

Note that in some instances, it may also be possible for a non-AP wireless device to determine to preempt an uplink transmission in a wireless local area network scenario. For example, such a wireless device could determine that a coexistence event is occurring at the wireless device, such that continuing the uplink transmission would cause interference and/or other undesirable effects to another wireless communication technology implemented by the wireless device. Such a scenario could occur when the wireless device is transmitting on an assigned resource unit of a trigger based (TB) uplink data frame in a multi user (MU) scenario, or when performing a single user (SU) uplink transmission, among various possibilities.

The AP wireless device may provide signaling indicating that the first data transmission is preempted (458). There may be multiple possible options for providing such signaling. As one possibility, a physical waveform configured to indicate transmission preemption may be provided by the AP wireless device to indicate that the first data transmission is preempted. The preemption waveform may be a pre-configured (e.g., specified) and memory-stored sequence. In some instances, various preemption waveforms may be defined or configured for various possible channel (or sub-channel) bandwidths.

According to some embodiments, such a preemption waveform may be inserted to preempt the first data transmission at any time (e.g., if transmission preemption is configured as possible for the first data transmission). In such a scenario, it may be the case that the intended recipient of the first data transmission may check continuously (e.g., at every symbol) for detection of the preemption waveform. Such processing may be performed in parallel to baseline processing of the data portion of the downlink frame, at least according to some embodiments. Any potential beneficiary wireless devices (e.g., wireless devices with active low latency traffic streams, as one possibility) may similarly monitor the first data transmission for detection of the preemption waveform. This may mean that such wireless devices do not enter a low power (e.g., sleep) mode during the first data transmission, e.g., even if the first data transmission is not directed to them, at least according to some embodiments. Once the transmission preemption is announced, the AP wireless device may stop transmission of the remainder of the first data transmission. The recipient of the first data transmission may correspondingly stop processing the first data transmission. At least in some instances, the recipient of the first data transmission may not generate or may otherwise refrain from transmitting an acknowledgement or block acknowledgement for the preempted first data transmission, e.g., in order to avoid causing interference to a potential second data transmission in favor of which the first data transmission was preempted.

As another possibility, an indication of whether the first data transmission is preempted may be provided at regular periodic intervals during the first data transmission (e.g., if transmission preemption is configured as possible for the first data transmission). In such a framework, if the AP wireless device determines to not preempt the first data transmission when a scheduled periodic preemption announcement is configured, a physical waveform configured to indicate that transmission is not preempted may be provided by the AP wireless device to indicate that the first data transmission is not preempted. When the AP wireless device determines to preempt the first data transmission, at the next scheduled periodic preemption announcement, a physical waveform configured to indicate that transmission is preempted may be provided by the AP wireless device to indicate that the first data transmission is preempted. In such a scenario, it may be the case that the intended recipient of the first data transmission may check at the configured intervals for detection of the preemption or no-preemption waveform. Any potential beneficiary wireless devices (e.g., wireless devices with active low latency traffic streams, as one possibility) may similarly monitor the first data transmission at the configured intervals for detection of the preemption or no-preemption waveform. This may mean that such wireless devices do not enter a low power (e.g., sleep) mode during the first data transmission, e.g., even if the first data transmission is not directed to them, at least according to some embodiments. It may also be possible that such devices are able to enter a reduced power mode during portions of the first data transmission between the periodic preemption announcements.

According to various embodiments, the periodicity of the preemption announcements may be configured per downlink frame (e.g., in conjunction with indication of whether transmission preemption is configured as possible for the first data transmission, as one possibility), or as a network parameter for the network provided by the AP wireless device (e.g., as a parameter configured and announced in a beacon frame, as one possibility), or may be defined as a specified parameter (e.g., in IEEE 802.11 Specifications, as one possibility). The preemption periodicity could be interpreted by beneficiary STAs as the period where the STA shall wake up and look for a new frame (e.g., to look for legacy preamble and L-STF), and, if detected, to process the received frame. If the start of a new frame is not detected, it may be the case that the STA may go back to sleep and wake up at the beginning of the next period to look for a new frame, and so on for any further such periods. The periodicity may be indicated in any of various possible units of measurement, such as symbols, bits, μs, etc. Once the transmission preemption is announced, the AP wireless device may stop transmission of the remainder of the first data transmission. The recipient of the first data transmission may correspondingly stop processing the first data transmission. At least in some instances, the recipient of the first data transmission may not generate or may otherwise refrain from transmitting an acknowledgement or block acknowledgement for the preempted first data transmission, e.g., in order to avoid causing interference to a potential second data transmission in favor of which the first data transmission was preempted.

As a still further possibility, instead of (or in addition to) use of a physical layer waveform to indicate transmission preemption, it may be possible to signal that transmission preemption is occurring for the first data transmission via MAC signaling. For example, one or more reserved bits in a MAC header, a new A-Control field, or one or more reserved bits in a MPDU delimiter could be used to indicate transmission preemption at the MAC layer, as various possibilities. In such a scenario, once the AP wireless device determines to perform downlink frame preemption for the first data transmission, the AP may add the new field in the earliest possible MPDU (e.g., considering processing time to generate the signaling), at least as one possibility. Note that in some embodiments, it may be possible for the MAC signaling indicating transmission preemption to be inserted by the PHY layer of the AP wireless device, e.g., to handle scenarios in which MPDUs are already pushed to PHY and the MPDU boundary to change the MAC header or MPDU delimiters is not known at PHY. For example, a pre-made MPDU configured to indicate transmission preemption may be stored at PHY and may be inserted by PHY whenever a preemption request is received from MAC (possibly with a preference for insertion at an A-MPDU subframe border). The content of such a pre-made MPDU or other MAC based transmission preemption signaling may be recognized by the receiver as a transmission preemption while performing baseline processing of the downlink frame. Any potential beneficiary wireless devices (e.g., wireless devices with active low latency traffic streams, as one possibility) may remain awake to process the downlink frame and similarly recognize such MAC based transmission preemption signaling. Once the transmission preemption is announced, the AP wireless device may stop transmission of the remainder of the first data transmission. The recipient of the first data transmission may correspondingly stop processing the first data transmission. At least in some instances, the recipient of the first data transmission may not generate or may otherwise refrain from transmitting an acknowledgement or block acknowledgement for the preempted first data transmission, e.g., in order to avoid causing interference to a potential second data transmission in favor of which the first data transmission was preempted.

Note that transmission preemption using physical layer waveform and/or MAC layer signaling can be applied in either or both of single-user or multi-user transmission scenarios, according to various embodiments. For MU scenarios, it may be possible to implement a partial preemption of a downlink frame, e.g., on a sub-channel basis or on a resource unit assignment basis.

After the transmission preemption (e.g., and potentially prior to completion of the originally scheduled duration of the first data transmission), the AP wireless device may initiate a second data transmission. The second data transmission may be initiated to transmit low latency data whose arrival triggered the transmission preemption for the first data transmission, at least according to some embodiments. The second data transmission may be directed to a different wireless device than the first data transmission, or possibly to the same wireless device as the first data transmission. The intended recipient of the second data transmission may receive and process the second data transmission.

For a MU scenario with partial preemption of a downlink frame, if the transmission preemption is performed on a sub-channel basis, it may be possible for the AP wireless device to provide new resource unit assignments for the preempted sub-channel, for example using a “preemption-SIG” header.

As another possibility for a MU scenario with partial preemption of a downlink frame, it may be possible for the AP wireless device to configure one or more resource unit reservations in advance, such that one or more wireless devices can be configured as a potential beneficiary for a resource unit of a MU downlink frame. In such a scenario, if transmission preemption is signaled for the resource unit (or for the sub-channel containing the resource unit), the potential beneficiaries may identify (e.g., from control information in the second data transmission) to which device the second data transmission is directed. Note that multiple such preemptions could be possible within the same MU downlink frame, e.g., to serve multiple potential beneficiary wireless devices. Such an approach could be used in either a resource unit-based approach or a sub-channel-based approach for partial transmission preemption within a multi-user downlink frame, according to various embodiments.

Note that in a scenario in which a non-AP wireless device determines to preempt an uplink transmission, the non-AP wireless device may also provide signaling indicating that the data transmission is preempted. The signaling could include MAC signaling, e.g., similar to a MAC signaling based approach to indicating transmission preemption by an AP wireless device for a downlink frame, at least as one possibility. In some instances, further information may be provided by the wireless device in conjunction with the transmission preemption signaling, such as an expected end time for a coexistence event that is triggering the transmission preemption, among other possibilities.

Note that identification of which wireless devices associated with an AP wireless device are potential beneficiaries of transmission preemption (e.g., and thus which wireless devices may determine to remain awake to monitor data transmissions directed to other wireless devices for possible preemption to their benefit) may be performed in any of a variety of possible ways. In some instances, such identification may follow logic defined and specified generally for communications in compliance with a wireless communication technology implemented by the AP wireless device. For example, certain traffic identifiers (e.g., associated with low latency traffic, or any of various other possible traffic types) may be used to identify potential beneficiaries of transmission preemption, e.g., such that wireless devices with active data flows for those traffic identifiers may implicitly be configured as potential beneficiaries of transmission preemption.

As another possibility, such identification could be performed in a more finely grained manner, for example according to rules or configuration parameters specific to the wireless network provided by the AP wireless device. For example, the AP wireless device could provide signaling in beacon frames to indicate one or more traffic identifiers that can be used to identify potential beneficiaries of transmission preemption, e.g., such that wireless devices with active data flows for those traffic identifiers may implicitly be configured as potential beneficiaries of transmission preemption.

As a still further and more finely grained option, the AP wireless device could configure wireless devices individually as potential beneficiaries of transmission preemption. For example, the AP wireless device could provide signaling to a wireless device indicating that the wireless device is a potential beneficiary of transmission preemption when a low-latency data flow or other high priority data flow is established between the AP wireless device and the wireless device, as one possibility. It should be further noted that numerous variations and alternatives to these approaches are also possible.

Thus, according to the method of FIG. 4, it may be possible to preempt transmissions in a WLAN setting, for example to provide better handling for low latency traffic and/or co-existence events, among various possibilities. Such techniques may provide improved latency for targeted traffic types, reduced need for error handling, reduced coexistence interference caused, and/or provide any of a variety of other possible benefits, at least according to some embodiments.

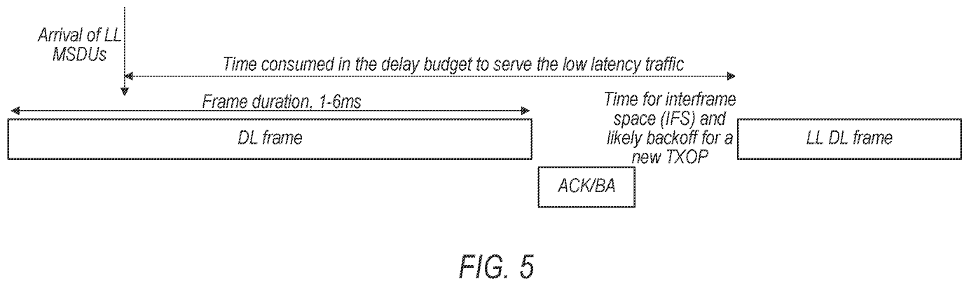

### FIGS. 5-20 and Additional Information

FIGS. 5-20 illustrate further aspects that might be used in conjunction with the method of FIG. 4 if desired. It should be noted, however, that the exemplary details illustrated in and described with respect to FIGS. 5-20 are not intended to be limiting to the disclosure as a whole: numerous variations and alternatives to the details provided herein below are possible and should be considered within the scope of the disclosure.

Some types of data traffic that can be communicated wirelessly may benefit from low latency. Different types of low-latency or delay intolerant traffic may be possible, with different “delay budgets.” For example, according to one set of embodiments, goals for addressing low-latency in upcoming IEEE 802.11 versions (e.g., Wi-Fi 8) could range from 1 ms-10 ms, at least according to one set of embodiments. Most of this delay budget may be used for obtaining channel access and air-time, at least in some instances. It may be the case that 802.11 frames could be longer than 1 ms; for example, in some embodiments, 2-4 ms frames may be common, and up to 6 ms frames can occur. Thus, if an AP serves a low-latency traffic stream as well as other more delay-tolerant traffic streams, it may commonly occur that a low-latency frame arrives while the AP is transmitting a long frame of the delay-tolerant traffic. In such a scenario, waiting for the long frame to end may consume most of the delay budget for the low-latency traffic. Moreover, it may be possible that the transmit opportunity (TXOP) may be over by the end of the ongoing frame, which may mean further delays for channel contention to obtain another TXOP. FIG. 5 illustrates such a possible transmission timeline in which low latency (LL) traffic (e.g., MSDUs) arrives during an ongoing delay tolerant downlink frame in a wireless local area network setting, and in which the LL traffic is accordingly delayed until completion of the downlink frame, ACK/BA transmission, and medium contention, according to some embodiments.

In 802.11 based wireless communication, a communication frame may generally have a single set of PHY control signaling transmissions (e.g., regardless of the frame length). For example, for legacy/ax/be embodiments, short training field (STF)/long training field (LTF) may be used; SIG-A/SIG-B fields may be also be used for signaling of PHY(/MAC) frame attributes and the basic service set (BSS) attributes. Other wireless communication technologies (e.g., 5G NR) may address transmission of low-latency traffics by canceling earlier scheduled transmissions or overwriting ongoing transmission, for example using downlink (DL) or uplink (UL) preemption features. For example, an earlier scheduler decision, which may already be announced to the respective device, may be cancelled (and possibly overwritten) and the new low-latency payload may be scheduled and transmitted.

There may be a variety of possible techniques for addressing LL traffic in Wi-Fi based operation. As one possibility, an AP may terminate transmission of an ongoing PPDU, and within a short interframe space (SIFS) may start transmission of the LL traffic. However, such unilateral and unsignaled interruption of a downlink frame could possibly result in ACK/BA for the already received MPDUs being received after the end of the ongoing/preempted PPDU, and/or could result in frequent error handling for the STA that was receiving the preempted downlink frame (which may also be referred to as a “victim STA” herein). As another possibility, an AP with urgent traffic may enforce a relatively short frame length (e.g., 1 ms, as one possibility), e.g., in order to be able to quickly schedule LL traffic. However, this could result in increased overhead, e.g., due to more frequent transmission of PHY overhead, more interframe space (IFS) instances and ACK/BA transmissions, and/or smaller-sized aggregated MPDUs (AMPDUs).

Approaches to transmission preemption in which transmission preemption signaling can be used to more gracefully handle the transmission preemption (e.g., to reduce the amount of error handling performed in case of transmission preemption) are also possible. According to one such possible approach, periodic explicit PHY signaling for transmission preemption may be used. Two PHY waveforms may be dedicated (and designed for various bandwidths), where one waveform is associated with not executing preemption and another waveform is associated with preemption execution. The presence and periodicity of the PHY preemption waveform may be indicated in a SIG field such as SIG-A or Universal-SIG (U-SIG): preemption presence (e.g., 0 or 1) and preemption announcement periodicity (e.g., M bits, symbols, μs, or other unit of measurement). The transmitting STA may thus set the preemption announcement in SIG-A (whether preemption is likely or not, and if so the periodicity of the preemption announcement instances), and may insert the no-preemption waveform during the symbols dedicated for preemption announcement instances, until preemption is required, at which time the preemption waveform may be transmitted at the next symbol dedicated as a preemption announcement instance.

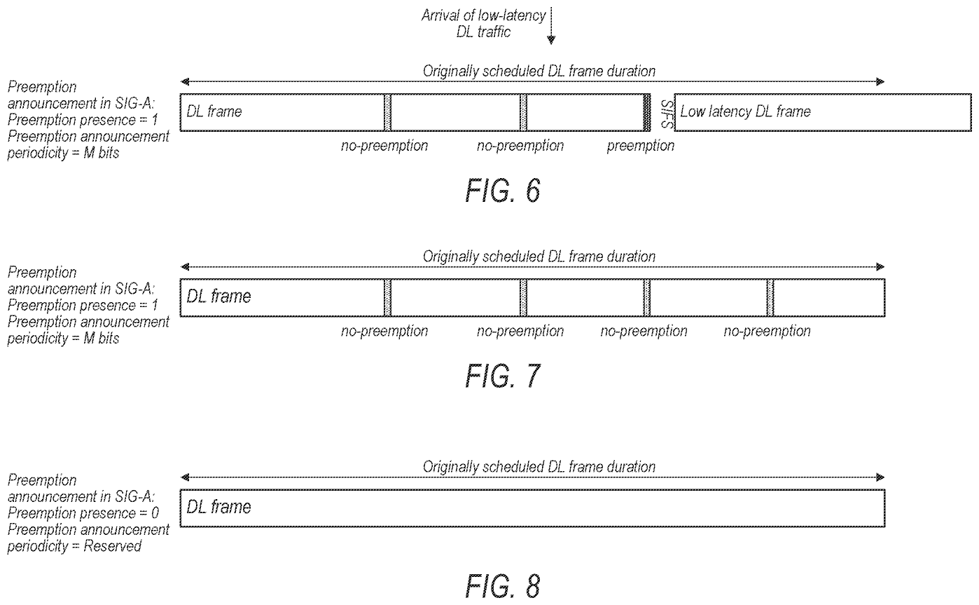

In such an approach, the victim STA may, in parallel with PHY data processing, process the received waveforms during the symbols as preemption announcement instances identified by the preemption announcement periodicity. Upon detection of the preemption waveform, the STA may abort processing of the remainder of the PPDU. For beneficiary STAs (e.g., those STAs for the benefit of which a transmission can be preempted), upon detection of the SIG-A/B of a PPDU, if the PPDU does not address the STA, but the SIG-A includes the possibility of DL-preemption, it may be the case that the STA does not go into a sleep state during the ongoing PPDU, e.g., instead monitoring the preemption announcement instances to determine whether a preemption waveform or a no-preemption waveform is present. FIGS. 6-8 illustrate possible example transmission timelines in which such an approach to transmission preemption is used, according to some embodiments. In particular, in FIG. 6, an example transmission timeline is illustrated for a scenario in which preemption occurs during a PPDU transmission, while in FIG. 7, an example transmission timeline is illustrated for a scenario in which preemption is possible but does not occur during a PPDU transmission, and in FIG. 8, an example transmission timeline is illustrated for a scenario in which preemption is not possible during a PPDU transmission.

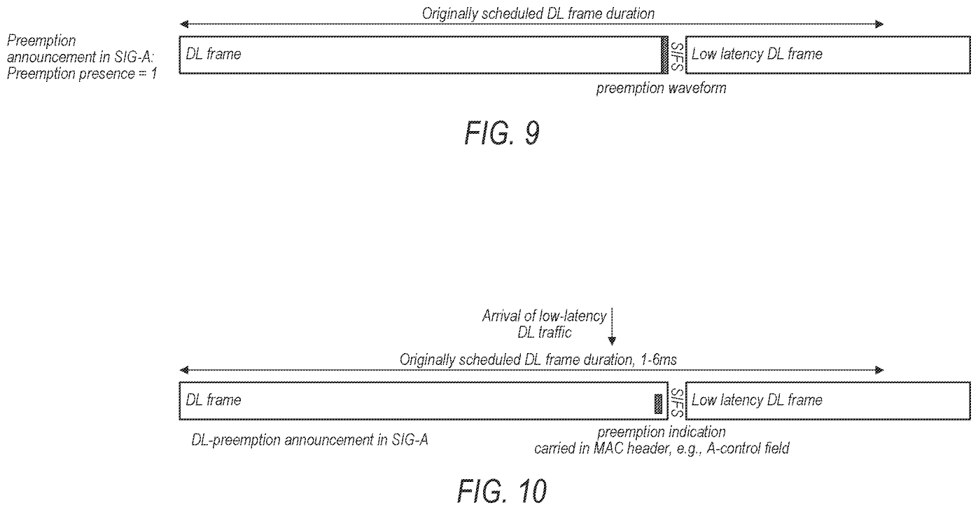

In another approach, non-periodic explicit PHY signaling for transmission preemption may be used. In such an approach, it may be the case that a PHY preemption waveform is defined that is not limited to insertion at periodic preemption announcement instances with locations announced in SIG-A; in other words, the transmitting STA may be able to insert the preemption waveform whenever it decides to (e.g., to preempt the remainder of the PPDU). The preemption waveform may be a pre-known/memory stored sequence for various bandwidths. The receiving victim STA may perform baseline PHY processing of the data portion of the PPDU, and both receiving victim and beneficiary STAs may check each OFDM symbol for detection of the preemption waveform. When the victim STA detects the preemption waveform, the victim STA may stop PHY processing of the rest of the PPDU. Such an approach may avoid the need (and associated overhead) for periodic preemption announcements, and may provide more precision on when to preempt the PPDU. However, it should be noted that it may be possible that detection of the preemption waveform in such an approach may be more susceptible to error (e.g., in case of data resembling the waveform, possibly depending on design of the preemption waveform) than a periodic PHY signaling based approach (e.g., in which case detection at preemption announcement instances may be binary between a preemption waveform and a no-preemption waveform). It may also be possible that a periodic PHY signaling based approach can allow for increased power saving for the beneficiary STAs relative to an aperiodic PHY signaling based approach, e.g., if it is possible for the beneficiary STAs to use reduced power between the configured preemption announcement instances. FIG. 9 illustrates a possible example transmission timeline in which such a non-periodic PHY signaling based approach to transmission preemption is used, according to some embodiments.

Still another approach may include the use of explicit MAC signaling for transmission preemption. In such an approach, the downlink preemption indication may be carried in MAC layer control information, e.g., in a new or existing field. For example, reserved bits/fields in MAC headers could be used, a new A-Control field could be added, or reserved bits in MPDU delimiters could be used, among various possibilities. An AP that has decided to perform DL preemption may, according to such an approach, add the new field or other MAC signaling in the earliest MPDU possible. The earliest possible MPDU may depend on the AP processing time to generate the signaling (for the MPDUs in the lower MAC buffer), at least in some instances. The AP may stop transmission of the remainder of the PPDU, after the last symbol that carries the MPDU with the MAC signaling indicating the transmission preemption. A SIFS after the end of the preempted PPDU, the AP may start transmitting the new PPDU. The victim STA may process MPDUs as in baseline, and, upon detection of the new field or other MAC signaling indicating the transmission preemption, may stop processing after the current MPDU. The BA scoreboard may be updated up to the preempted point. The MAC layer may inform PHY that the ongoing PPDU is preempted, and the STA may not generate ACK/BA. At least in some instances, a beneficiary STA may not go to sleep if there is a chance of transmission preemption (e.g., if a DL-Preemption Announcement is set). FIG. 10 illustrates a possible example transmission timeline in which such a MAC signaling based approach to transmission preemption is used, according to some embodiments. The MAC signaling may be intended for the recipient of the ongoing frame and/or the victim STA, and upon its detection the STA may stop processing the remaining of the frame (and may refrain from transmitting an acknowledgment response frame to the already received MPDUs). The STA(s) expecting a possible preemption, or the beneficiary STA(s), may rely on detection of a new start-of-packet when the preemption happens. For instance, it may be the case that such STAs would either stay awake during the ongoing DL frame when expecting a preemption event, or may go to sleep mode and periodically come back out of sleep and check if a new frame starts (e.g., detecting L-STF, etc.). The periodicity with which a beneficiary STA wakes up may be signaled by the AP in the SIG-A or U-SIG field, in some embodiments.

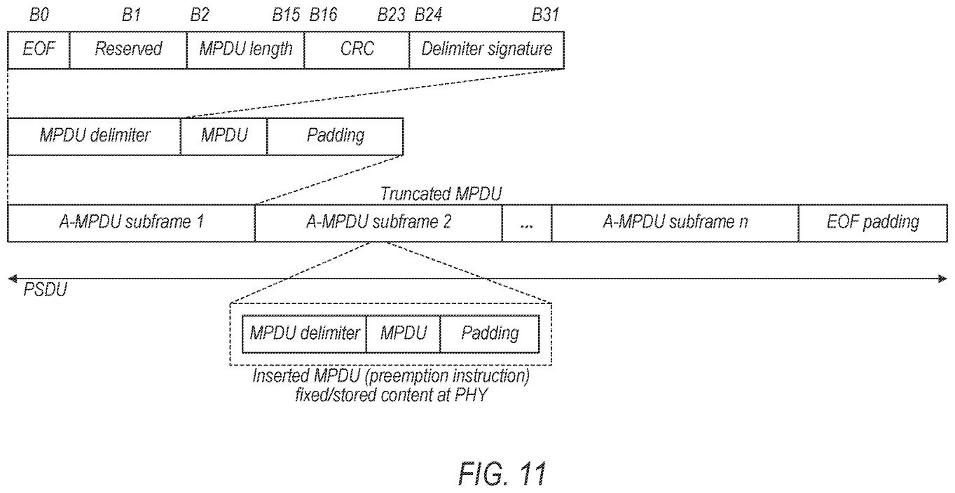

Note that it may be the case, in some instances, that MPDUs are already pushed to PHY when LL DL traffic arrives and an AP determines to preempt a downlink transmission. PHY may not know the MPDU boundary or be capable of changing the MAC header or MPDU delimiters in such a way as to insert the MAC control signaling to indicate transmission preemption. To handle such a scenario, it may be possible to support insertion by PHY of a pre-made and pre-stored MPDU configured to include MAC control signaling to indicate transmission preemption when a preemption request is received from MAC, at least in some scenarios. The content of the MPDU may be fixed/stored and its purpose may be to be interpreted by the receiver as a preemption indication. As one possible design option, MPDU length=0, EOF=1, and Reserved->Preemption=1 may be used as parameters in the pre-made MPDU. As another possible design option, a non-zero-length MPDU with preemption indication carried in A-Control can be used for the pre-made MPDU. As a still further design option, a new delimiter signature may be introduced (e.g., with zero-length MPDU) for the pre-made MPDU. If the MAC layer can inform PHY of the MPDU boundaries, PHY may be able to insert the pre-made MPDU as soon as possible after an A-MPDU subframe, i.e., at the boundary with the next A-MPDU subframe, otherwise it may be possible for PHY to insert the special MPDU in the middle of an existing MPDU. In such a scenario, the receiver may interpret the truncated MPDU as an erroneous MPDU. PHY assumptions to support such interpretation may include byte boundary being known to PHY and insertion occurring before any PHY processing. FIG. 11 illustrates details of an exemplary possible PHY service data unit (PSDU) into which such a special MPDU with preemption instruction can be inserted, according to some embodiments.

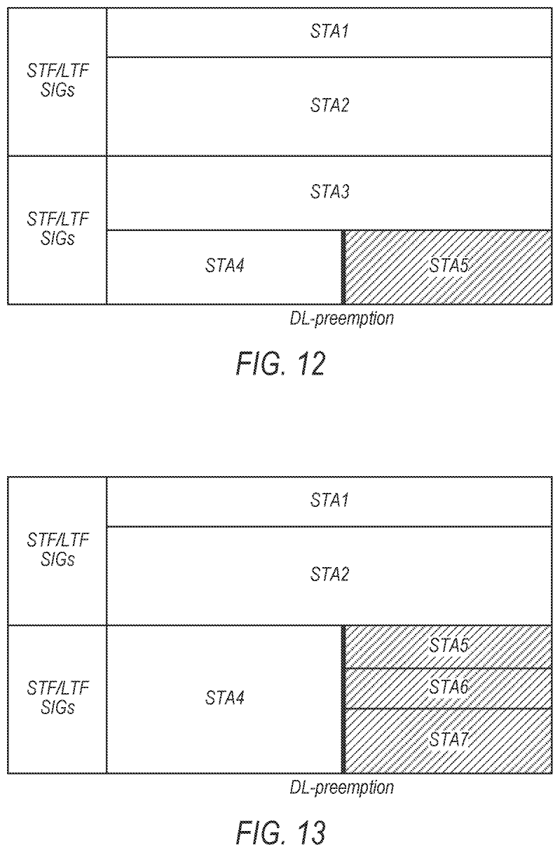

Signaled transmission preemption (e.g., using one of the approaches described herein) can be used for multi-user downlink frames as well as for single user downlink frames, at least according to some embodiments. In some embodiments, it may further be possible to perform partial DL MU PPDU preemption. For example, a partial preemption of a DL MU PPDU may take place on a per resource unit assignment basis, e.g., with the victim STA being replaced with a beneficiary STA. FIG. 12 illustrates example aspects of such a per-resource unit assignment based partial transmission preemption in a MU PPDU, according to some embodiments. As another example, a partial preemption of a DL MU PPDU may take place on a per 20 MHZ sub-channel basis (e.g., with the possibility to have new resource unit assignments with new PHY attributes on the sub-channel after the transmission preemption). FIG. 13 illustrates example aspects of such a per-sub-channel based partial transmission preemption in a MU PPDU, according to some embodiments.

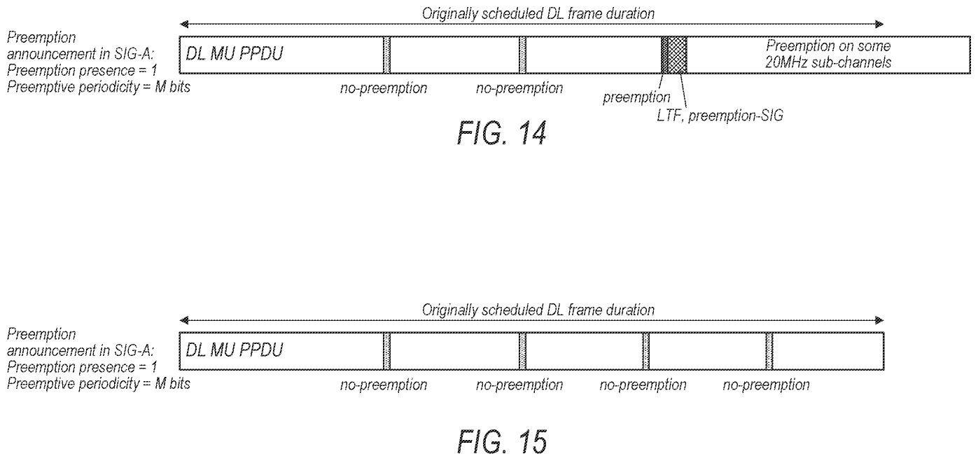

For a per-sub-channel based approach, it may be the case that a (new) SIG field (e.g., similar to SIG-A/B, 802.11be U-SIG, per 20 MHz) may be defined to carry the DL preemption information after a transmission preemption is signaled on a 20 MHz sub-channel. The “Preemption-SIG” field may carry new RU assignment(s) for the beneficiary STA(s), e.g., including all PHY attributes, etc. STF and/or LTF may also be provided after the preemption, e.g., if number of spatial streams (NSS) (for the beneficiary STA) is different. Such fields may be provided conditionally, e.g., if preemption occurs. For the per-sub-channel based approach, it may be possible to use any of a periodic PHY preemption waveform based approach, a non-periodic PHY preemption waveform based approach, or a MAC signaling based approach, according to various embodiments. As an example, FIGS. 14-15 illustrate possible transmission timelines with and without transmission preemption for a multi-user transmission, in which a periodic PHY preemption waveform-based approach is used for the transmission preemption signaling. In the example scenario of FIG. 14, in which preemption does occur on one or more 20 MHz sub-channels, the preemption announcement may be provided in SIG-A, including indicating presence (value=1) and periodicity. The no-preemption waveform may be inserted on the occasions until a preemption request is received from MAC. At that time, the preemption waveform may be inserted at the next occasion, followed by LTF, followed by Preemption-SIG. In the example scenario of FIG. 15, in which preemption is announced but does not occur during a MU PPDU transmission, the preemption announcement may be provided in SIG-A, including indicating presence (value=1) and periodicity. The no-preemption waveform may be inserted on all of the configured preemption announcement occasions, and preemption may not occur.

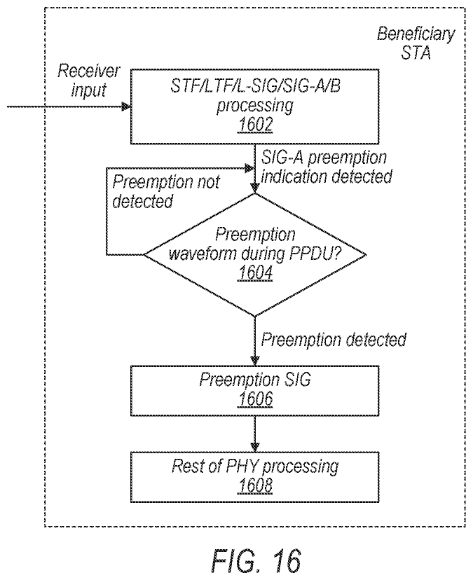

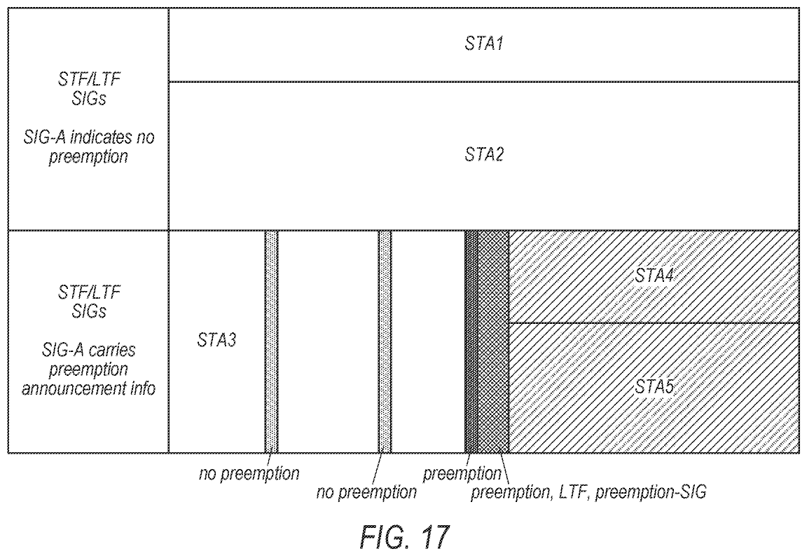

From the victim STA perspective, preemption detection may be based on detection of the PHY preemption waveforms (e.g., according to a periodic approach, as in the example scenarios of FIGS. 14-15, or a non-periodic approach. Alternatively, as previously noted herein, it may be possible for a victim STA to detect MAC-based preemption signaling in a MU PPDU scenario. FIG. 16 is a flowchart diagram illustrating an example method for a wireless device that is a beneficiary of transmission preemption during a multi-user PPDU, according to some embodiments. As shown, from the beneficiary STA perspective, STF/LTF/L-SIG/U-SIG/SIG-A/B processing may be performed when a MU PPDU is detected (1602). If SIG-B (or 11 be EHT-SIG) does not address the STA but the preemption announcement in SIG-A indicates possibility of preemption, the STA may not go to sleep during the MU PPDU duration. The STA may determine whether a preemption waveform is detected during the PPDU (1604). For example, at each occasion of a preemption announcement instance, if the no-preemption waveform is detected, the STA may skip to the next occasion. If the preemption waveform is detected, the STA may process the Preemption-SIG field that follows (in the respective 20 MHz sub-channel) (1606). If the STA AID is present in the new RU assignments in the Preemption-SIG, the STA may begin processing the assigned RU (1608). FIG. 17 illustrates a possible transmission timeline with transmission preemption for a multi-user transmission, in which new RU assignments are provided after the transmission preemption using a preemption-SIG field.

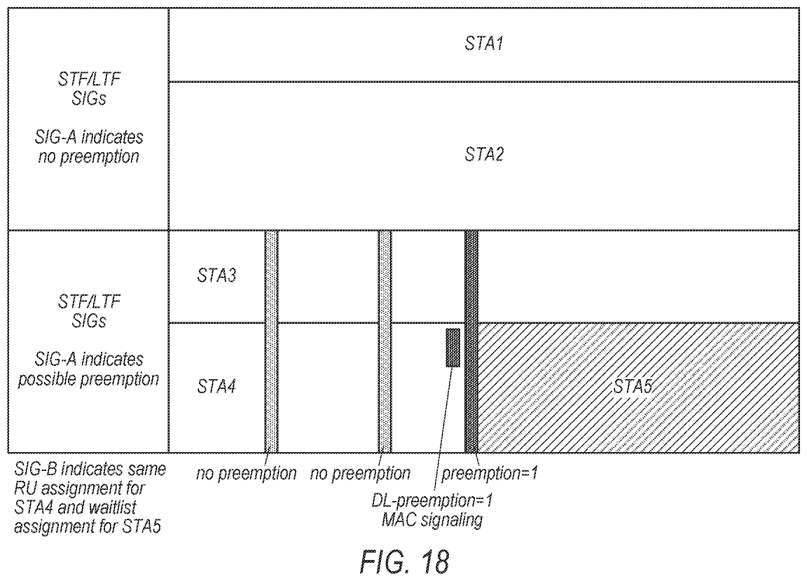

In some embodiments, it may be possible to use combined MAC and PHY signaling to define victim and beneficiary STA behaviors in such a manner as to support a waitlist RU reservation-based approach to partial transmission preemption during a DL MU PPDU. FIG. 18 illustrates aspects of an example such scenario in which transmission preemption is performed per-20 MHz sub-channel (e.g., even though waitlist RU reservation may be configured for only a subset of RU assignments within the 20 MHz sub-channel), according to some embodiments. As shown, in the illustrated example, PHY preemption (waveform) signaling may be inserted for each 20 MHz sub-channel in which transmission preemption is indicated as possible (e.g., PHY preemption can be enabled for selected 20 MHz sub-channels). The transmitting STA may need to insert STF and/or LTF after the preemption for beneficiary STA PHY processing. MAC preemption signaling may also be provided (possibly only for the preempted RU), if/when the AP decides to preempt a transmission. SIG-B (or 802.11be EHT-SIG) signaling may be provided for the beneficiary STA(s) to indicate that they have a waitlist RU reservation. In such a scenario, a victim STA may implement preemption behavior based on the MAC signaling; for example, the STA may skip any scheduled PHY preemption symbols; if MAC preemption is detected, the STA may abort processing of the remainder of the RU assignment of the MU PPDU. Further, the STA may not respond to implicit multi-user block acknowledgement request (MU-BAR), if present. A beneficiary STA may implement preemption behavior based on the PHY signaling; for example, the STA may process the initial STF/LTF/SIGs as in baseline, and additionally, if the STA is configured in a RU waitlist, the STA may perform detection of PHY preemption waveforms for each preemption announcement OFDM symbol. The STA may skip any no-preemption waveforms, and if a PHY preemption waveform is detected, the STA may start baseline PSDU processing (possibly after a configured amount of time) after the PHY preemption signaling. Thus, it may be the case that the SIG-B can indicate allocation of the same RU(s) for two or more STAs; in the illustrated example of FIG. 18, STA4 may be the main STA for the bottom RU, while STA5 may be a potential beneficiary STA, with full RU allocation info in SIG-B. STA4 may process the entire RU assignment, unless the AP preempts it via MAC preemption signaling. STA5 may perform detection on the OFDM symbols that carry either of the PHY preemption waveforms. If the no-preemption waveform is detected, STA5 may skip to the next; STA5 may start baseline PHY processing after the preemption waveform is detected. To enable a different NSS for STA5 (e.g., vs. STA4), LTF symbols may follow after the preemption waveform; otherwise, the number of NSS for STA4 and STA5 may be the same. Different MCS may be as indicated in the SIG-B portions for STA4 and STA5 respectively. Note that waitlist allocation could be for an AID that is pre-assigned to a set of STAs, e.g., where all or a subset of expecting STAs begin processing the payload after the preemption. MCS and NSS may be the same for all STAs in the set. The beneficiary STAs may be able to determine to which STA in the set the waitlist allocation is provided based on MAC header information in the payload, at least as one possibility.

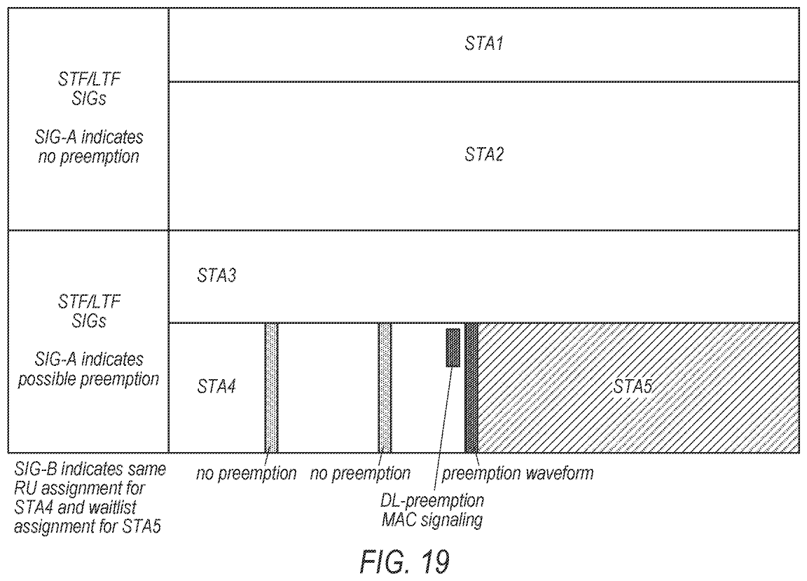

As an alternative approach to supporting waitlist RU reservations to enable partial transmission preemption in a MU PPDU, it may be possible that the preemption waveform is inserted only on the RU for which possible preemption is configured. FIG. 19 illustrates example aspects of such an alternative scenario in which transmission preemption is performed per RU assignment, according to some embodiments. Such an approach may be similar to the approach of FIG. 18, except that the PHY preemption waveform is inserted only for the intended RU(s). Such an approach may require various possible sizes of PHY waveform (e.g., based on various RU sizes possible), and may possibly have reduced detection reliability (e.g., for frequency domain detection of a potentially shorter waveform), but may avoid PHY preemption waveform transmission overhead on the RU(s) on which the AP does not intend to enact transmission preemption.

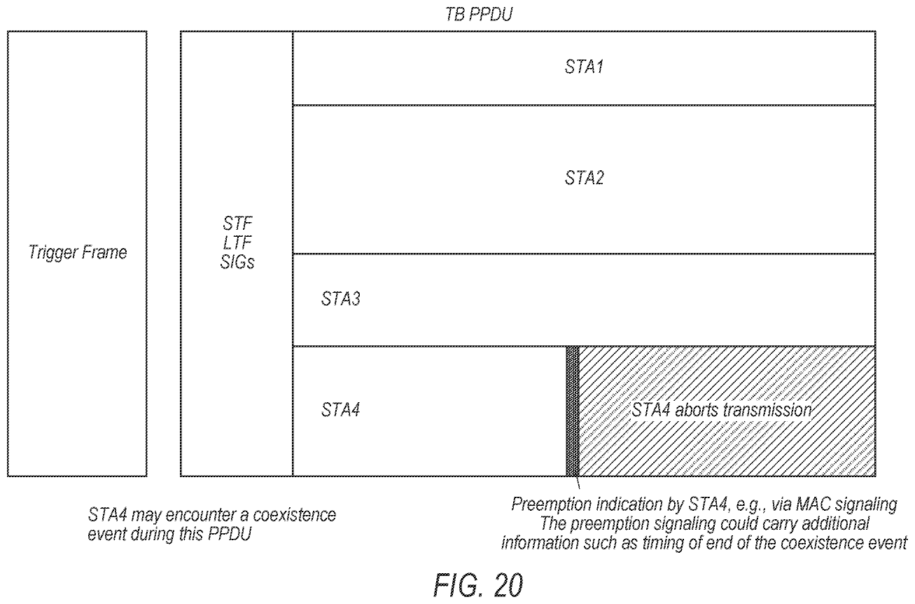

Note that there may be other possible scenarios in which transmission preemption can be used, e.g., in a Wi-Fi based wireless communication scenario or otherwise. For example, a use case for transmission preemption could occur in which a STA uses MAC (and/or PHY) preemption signaling in order to stop transmission of the remaining portion of its ongoing uplink PPDU. FIG. 20 illustrates example aspects of such a scenario, e.g., in which a STA aborts transmission during a trigger based (TB) uplink (UL) MU PPDU. In the example scenario, STA4 may be using the same radio for multiple wireless communication technologies. Based on internal device scheduler decision-making, the transmission of the ongoing PPDU may be deprioritized in favor of transmission/reception of another wireless communication technology. This may be referred to as a co-existence event, at least according to some embodiments. STA4 may accordingly perform preemption via MAC and/or PHY signaling in a similar manner as previously described herein (MAC signaling may be used in the scenario of FIG. 20). When preemption via MAC signaling is used, it may be possible for the STA to provide additional information, for example to let the recipient (e.g., AP) know when the STA would again be available after the coexistence event, and/or any of various other possible types of information. The preemption indication may help the recipient of the frame (e.g., the AP, in this scenario) to perform proper PHY and MAC processing; for example, the AP may withhold the ACK/BA (e.g., until a BAR is received from STA4). Additionally, the AP may adjust its internal RF/PHY circuitry for the remaining portion of the PPDU in which the transmission of STA4 is absent, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a first wireless device:
establishing a wireless association with a second wireless device;
initiating a first data transmission to the second wireless device, wherein the first data transmission is configured for a first duration;
determining to preempt the first data transmission prior to completion of the first duration; and
transmitting signaling indicating that the first data transmission is preempted prior to completion of the first duration.

2. The method of claim 1, wherein the method further comprises:
receiving data configured for transmission as a low-latency frame,
wherein determining to preempt the first data transmission prior to completion of the first duration is based at least in part on receiving the data configured for transmission as a low-latency frame; and
initiating a second data transmission to transmit the data configured for transmission as a low-latency frame after transmitting the signaling indicating that the first data transmission is preempted, wherein the second data transmission is initiated prior to completion of the first duration.

3. The method of claim 1, wherein the method further comprises:
determining that a coexistence event is occurring at the first wireless device,
wherein determining to preempt the first data transmission prior to completion of the first duration is based at least in part on the coexistence event occurring at the first wireless device.

4. The method of claim 3,
wherein the signaling indicating that the first data transmission is preempted further includes information indicating an expected end time for the coexistence event occurring at the first wireless device.

5. The method of claim 1, wherein the method further comprises:
providing signaling including resource unit waitlist reservation information for the first data transmission, wherein the resource unit waitlist reservation information indicates one or more wireless devices for which preemption of the first data transmission may be performed; and
initiating a second data transmission to one of the wireless devices for which preemption of the first data transmission may be performed after transmitting the signaling indicating that the first data transmission is preempted and prior to completion of the first duration.

6. An apparatus, comprising:
a processor configured to cause a wireless device to:
establish a wireless association with an access point (AP) wireless device;
receive signaling indicating that the AP wireless device is performing a first data transmission to the wireless device for a first duration;
receive the first data transmission from the AP wireless device;
receive signaling indicating that the first data transmission is preempted prior to completion of the first duration; and
abort processing the first data transmission based at least in part on the signaling indicating that the first data transmission is preempted.

7. The apparatus of claim 6,
wherein control information for the first data transmission includes an indication of whether preemption of the first data transmission is possible.

8. The apparatus of claim 6,
wherein control information for the first data transmission includes an indication of a periodicity at which signaling indicating whether the first data transmission is preempted is provided during the first data transmission, wherein the processor is further configured to cause the wireless device to:
receive signaling indicating whether the first data transmission is preempted at the indicated periodicity during the first data transmission.

9. The apparatus of claim 6,
wherein the signaling indicating that the first data transmission is preempted includes a physical layer waveform configured to indicate that data transmission preemption is occurring.

10. The apparatus of claim 6,
wherein the signaling indicating that the first data transmission is preempted includes media access control (MAC) signaling configured to indicate that data transmission preemption is occurring.

11. The apparatus of claim 6,
wherein the signaling indicating that the first data transmission is preempted is transmitted on a 20 MHz sub-channel of a multi-user physical protocol data unit.

12. The apparatus of claim 6,
wherein the signaling indicating that the first data transmission is preempted is transmitted on a configured resource unit assignment for the first data transmission within a 20 MHz sub-channel of a multi-user physical protocol data unit.

13. A wireless device, comprising:
one or more antennas;
a radio operably coupled to the one or more antennas; and
a processor operably coupled to the radio;
wherein the wireless device is configured to:
establish a wireless association with an access point (AP) wireless device;
receive signaling indicating that the AP wireless device is performing a first data transmission for a first duration;
receive signaling indicating that the first data transmission is preempted prior to completion of the first duration;
receive signaling indicating that the AP wireless device is performing a second data transmission to the wireless device, wherein the second data transmission is initiated prior to completion of the first duration; and
receive the second data transmission from the AP wireless device.

14. The wireless device of claim 13,
wherein control information for the first data transmission includes an indication of whether preemption of the first data transmission is possible.

15. The wireless device of claim 14,
wherein control information for the first data transmission includes an indication that the first data transmission is directed to a different wireless device, wherein the wireless device is further configured to:
determine to monitor the first data transmission for signaling indicating that the first data transmission is preempted based at least in part on the indication of whether preemption of the first data transmission is possible.

16. The wireless device of claim 15,
determine that a low latency data flow is active for the wireless device;
wherein determining to monitor the first data transmission for signaling indicating that the first data transmission is preempted is further based at least in part on the low latency data flow being active for the wireless device.

17. The wireless device of claim 13,
wherein control information for the first data transmission includes an indication of a periodicity at which signaling indicating whether the first data transmission is preempted is provided during the first data transmission, wherein the wireless device is further configured to:
receive signaling indicating whether the first data transmission is preempted at the indicated periodicity during the first data transmission.

18. The wireless device of claim 17,
wherein new frame signaling is used to indicate that the first data transmission is preempted,
wherein if no new frame signaling is present at the indicated periodicity, the wireless device is further configured to determine that the first data transmission is not preempted.

19. The wireless device of claim 13,
wherein the signaling indicating that the first data transmission is preempted includes one or more of:
a physical layer waveform configured to indicate that data transmission preemption is occurring; or
media access control (MAC) signaling configured to indicate that data transmission preemption is occurring.

20. The wireless device of claim 13,
wherein the signaling indicating that the first data transmission is preempted is transmitted on one of:
a 20 MHz sub-channel of a multi-user physical protocol data unit; or
a configured resource unit assignment for the first data transmission within a 20 MHz sub-channel of a multi-user physical protocol data unit.
